(19) United States
(12) Patent Application Publication
(10) Pub. No.: US 2026/0150792 A1
(43) Pub. Date: Jun. 4, 2026

(54) CONTAINER FOR TRANSPORT OF ROOTED PLANT CUTTINGS

(71) Applicant: Rijoh Veredeling B.V., Delft (NL)

(72) Inventors: Paulus Marinus Maria ZWINKELS, Delft (NL); Andrew HAMILTON, Delft (NL)

(21) Appl. No.: 19/364,619

(22) Filed: Oct. 21, 2025

Related U.S. Application Data
(63) Continuation-in-part of application No. 18/705,106, now abandoned.

(30) Foreign Application Priority Data
Nov. 3, 2021 (NL) 1044197

(51) Int. Cl. A01G 9/029; B65D 21/02; B65D 25/04; B65D 85/52

(52) U.S. Cl. CPC A01G 9/0295; A01G 9/0299; B65D 21/0213; B65D 25/04; B65D 85/52

(57) ABSTRACT

Container (1) for the transport of rooted plant cuttings (2), wherein the container comprises upright walls (3) which are made substantially of wood or rigid woody material. Grids (4) may be received between the walls, each grid being arranged to receive plant cuttings. The grids may also be made of wood or rigid woody material. The container is arranged and shaped so as to be stackable by form fit with similar containers. A loose base (5) is arranged and shaped so as to cooperate by form fit with the walls of the container.

### RELATED APPLICATION

The present application is a continuation-in-part of U.S. patent application Ser. No. 18/705,106, filed Apr. 26, 2024, which claims priority from and the benefit of PCT Application No. PCT/NL 2022/050595, filed Oct. 20, 2022, which claims priority from and the benefit of Netherlands Application No. 1044197, filed Nov. 3, 2021, the disclosures of which are hereby incorporated herein by reference in full.

### FIELD

The present invention relates to a container designed and arranged for the transport of rooted plant cuttings.

### BACKGROUND

The applicants are concerned with the production and transport of rooted plant cuttings from Africa. In this sector, usually cardboard boxes are used as packing for the transport of such rooted plant cuttings. Unfortunately, the shipments sometimes reach the Netherlands in very poor state: the cardboard boxes are often damaged, fall out of one another or collapse. In addition, on arrival, the plant cuttings are sometimes no longer neatly held in the grid intended for this, and slide around in the boxes. The problem of cardboard boxes is also that they are provided with a water-repellent wax which must offer protection against moisture. If the plant cuttings are watered and the cardboard becomes wet, the cardboard loses its rigidity. Providing the cardboard box with a water-repellent wax is an attempt to prevent this, but in many cases the boxes still collapse. An additional problem is that such wax-treated cardboard boxes cannot be disposed of as cardboard waste, but as paid landfill waste. As well as this cost, a high freight tariff is also applicable because the cardboard boxes are relatively heavy. Also, at present-and probably also in the future cardboard is very difficult to obtain and expensive because of the enormous growth in mail order business.

### SUMMARY

The present invention proposes to offer a solution to the problems outlined above.

For this, according to the invention, a container is provided which is designed and arranged for the transport of rooted plant cuttings, wherein the container comprises upright walls which are made substantially of wood or rigid woody (ligneous) material, preferably certified wood from forestry, grown for example from pine wood. The wood can be cut up by the growers and milled and mixed into potting soil (loam), so there is no waste or disposal costs. This makes it a circular and environmentally friendly alternative which is also much more rigid and suitable for purpose.

The container is preferably arranged so as to be able to receive between its walls a grid or several grids one above the other, each grid being arranged to receive plant cuttings. The grid or several grids are preferably also made of wood or rigid woody material.

Preferably, the container is designed such that its walls are arranged and shaped so as to be stackable by form fit with similar containers, in particular the walls thereof.

The container according to the invention comprises a loose base which is arranged and shaped so as to cooperate by form fit with the walls of the container.

The container according to the invention—also described below as a plant tray—is made for example from thin solid wood or plywood, from wood which comes from local forestry.

By use of wood or woody material, a substantially more rigid container is obtained than by use of wax-treated cardboard boxes (see above). The containers according to the invention are lighter in weight than cardboard boxes, which brings the advantage of a lower freight tariff. In addition, the cuttings can be watered in the container without weakening the container. In contrast to cardboard, wood is more moisture-resistant.

Another advantage is that the grid is able to transport many plant cuttings per layer, for example three layers each with over 100 cuttings, which brings a loading advantage of around 50%. Because little air/space remains between the layers, the plant cuttings also remain neatly in place in the grid. Thus for example a plant robot can easily unpack the cuttings on arrival, which (see above) is not possible with a cardboard box in which the cuttings often slide around. This is thus a further important efficiency saving being achieved.

### BRIEF DESCRIPTION OF THE FIGURES

The invention will now be described in more detail with reference to the following description of the figures.

FIG. 1 shows an exemplary embodiment of a container according to the invention.

FIG. 2 is an exploded perspective view of three containers that can be assembled to form a container stack according to embodiments of the invention.

FIG. 3 is a mostly assembled perspective view of the containers of FIG. 2 formed into a container stack.

FIG. 4 is a bottom perspective view of the base of the containers of FIG. 2.

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

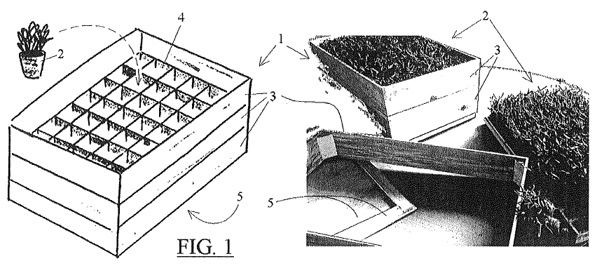

FIG. 1 shows an exemplary embodiment of a container 1 according to the invention, designed and arranged for the transport of rooted plant cuttings 2, wherein the container 1 comprises upright container walls 3 which form a rectangle and which are substantially made of wood or rigid woody material.

The container 1 shown in FIG. 1 is arranged so as to be able to receive between its walls 3 a grid 4 or several grids 4 above one another, each grid 4 including intersecting dividers 9 that are arranged to form rectangular compartments to receive plant cuttings 2 (in pots for example). The grid 4 or several grids 4 are also made of wood or rigid woody material. The container 1 comprises a loose base 5 which is arranged and designed to cooperate by form fit with the walls 3 of the container 1.

The container 1, in particular the walls 3 thereof, is arranged and shaped so as to be stackable by form fit with similar containers 1, in particular the walls 3 thereof: because the shapes of two containers 1 stacked on top of one another fit into one another (“form fit” or “form fit connection”; www.google.com/search?q=form+fit+connection), a firm stackability of the containers is achieved so that they cannot move around during transport.

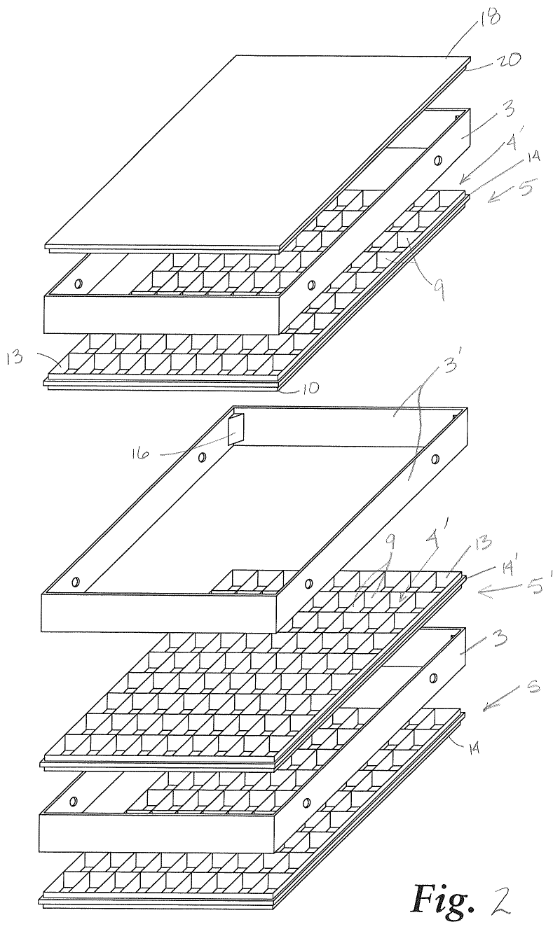

The stackability of the containers 1 can be further understood by reference to FIGS. 2-4. As shown in FIGS. 2 and 4, the loose base 5 comprises slats 10 that form the lower surface, and further includes side walls 13 of the loose base 5. The grid 4 is attached to the upper surfaces of the slats 10 between the side walls 13. A perimeter lip 14 is routed around the side walls 13 of the loose base 5. Also, as seen in FIG. 2, the walls 3 of the container 1 form a hollow square or rectangle. Braces 16 having a triangular profile are mounted in each intersecting corner of the container walls 3. The upper and lower surfaces of the braces 16 are recessed from the upper and lower edges of the walls 3.

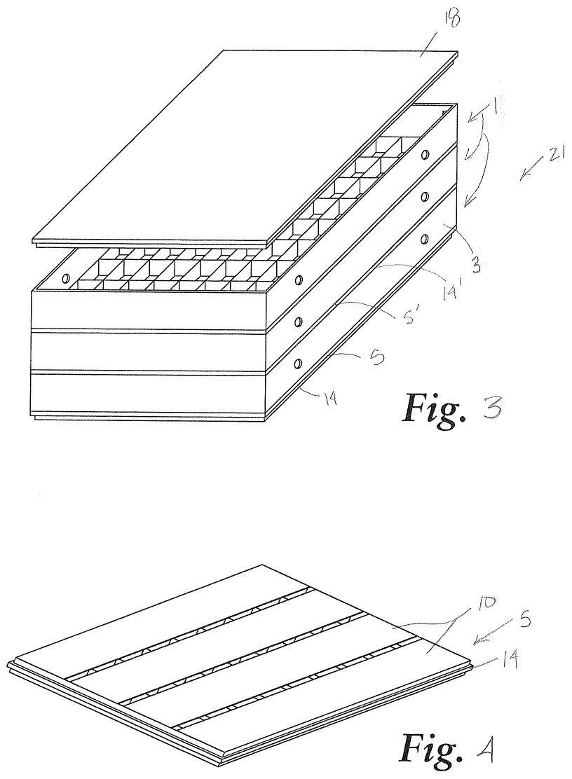

As can be seen in FIGS. 2 and 3, a container 1 is formed by positioning the container walls 3 on a base 5 with a grid 4. The lower edges of the container walls 3 rest on the upper surface of the lip 14, and the lower surfaces of the braces 16 rest on the upper corners of the walls 13 of the grid 4. A second base 5′ with its grid 4′ can then be stacked on the upper edges of the container walls 3, with the lower surface of the lip 14′ of the base 5′ resting on the upper edges of the container walls 3 and/or the lower corners of the surface formed by the slats 10 resting on the upper surfaces of the braces 16 of the container walls 3. A second set of container walls 3′ can then be stacked on the base 5′ in the manner described above. Stacking can be repeated, alternating bases 5 (with their accompanying grids 4) with walls 3 until a desired height is reached. A cover 18 with a lip 20 can then overlie the uppermost container 1 to form a container stack 21 (see FIG. 3).

Thus, the present invention provides a solution for the various problems outlined above with cardboard boxes, while providing a very environmentally friendly, easily reusable and (finally) recyclable product.

In the report on the prior art search which was carried out on 14 Jun. 2022, the examiner for his novelty objections refers to documents FR888854A of 24 Dec. 2042 (referred to below as ‘D1’) and GB01952A A.D. of 19 Sep. 2012(‘D2 ’).

D1 discloses a growing or cultivating container which is designed and arranged for promoting and protecting the growth of the root ball and roots of plants (cuttings) for a relatively long time, for example so that the plants (cuttings) can be stored by the retailer or end user. For this, plants (cuttings) are planted in cylindrical tubes without base, whereby an open space exists in which the roots can grow. However, the container from D1 is not intended for stacking. On stacking of D1, the freshly sprouted or germinated plants become trapped or damaged, with the possible result of dead plants. The container shown in D1 is essentially a growing or cultivating container and not able to be transported in stacks when filled with plants (cuttings).

D2 describes a growing or cultivating container with a glass cover on the top side and drainage holes on the underside. These properties logically make the container unsuitable for stacked transport. If the containers from D2 are to be transported while filled with plants (cuttings), there is a risk that undesirably moisture and soil will reach the transport means through of the drainage holes on the underside of the container. This may be dangerous. In addition, because of the glass cover, D2 is not stackable, because this would block the incidence of light. D2 is designed and arranged as a long-term growing or cultivating container but is not suitable for stacked transport when filled with plants (cuttings).

Neither D1 nor D2 show a container with upright walls and a loose base which container is designed and arranged to cooperate by form fit with a similar container which can be stacked by placing on the top. Stacking of growing or cultivating containers from D1 and D2 is not possible. If the containers from D1 and D2 are stacked, during transport the stacks could easily fall over due to vibration and movement of the vehicle.

The examiner refers for inventiveness objections to WO 2009/116959A1 of 24 Sep. 2009 (‘D3’) and US 2007/137101A1 of 21 Jun. 2007 (‘D4’).

D3 discloses (plant) trays which can be stacked one above the other. However, stacking with D3 is not possible if the trays are filled with plants (cuttings). For transporting plants (cuttings), wherein the space of the transport means in the height must be utilized as efficiently as possible, the tray from D3 offers no solution, even in combination with the growing and cultivating containers from D1 and D2 intended for longer-term use, which are not originally designed and arranged for stacking. The average person skilled in the art and familiar with D1, D2 and D3 would not reach the invention without further inventive activity.

D4 discloses trays which are stackable even when the trays are filled with plants (cuttings), but the device from D4 is completely open. While transporting filled plant trays from D4, undesirably moisture and soil will reach the transport means. This may be dangerous. In addition, the open system from D4 exposes the plants (cuttings) to contamination by bacteria and insects from outside, to which young plant cuttings are especially susceptible. Also, on vibration or falling of the stacked trays, the plant cuttings may come out of the grid and reach the transport means. This is undesirable. D4 is therefore unsuitable as such for transport in a transport means.

The present invention offers a solution for the outlined problems of D3 and D4. In contrast to D3, according to the invention several layers with grids filled with plants (cuttings) can be transported stacked one above the other.

In contrast to D4, the plant cuttings according to the invention remain protected by the upright walls against contamination by bacteria and insects from the outside. The closed system according to the invention also ensures that, on vibration or falling of the stacked containers, the plant cuttings remain in their place in the grid.

1. A container designed and arranged for the transport of rooted plant cuttings, comprising:
a base having a lower surface, a grid mounted on the lower surface, and grid walls surrounding the grid, the grid comprising a plurality of compartments, the base further including a peripheral outwardly-extending lip extending from the grid walls; and
container walls configured to rest atop the lip and surround the grid, the container walls including braces in intersecting corners thereof, the braces having upper and lower surfaces and being sized and positioned so that the lower surfaces rests on or above upper corners of the grid walls;
the container being made substantially of wood or rigid woody material.

2. The container as claimed in claim 1, further comprising a cover that rests atop the upper surface of the container walls and or the upper surfaces of the braces.

3. The container as claimed in claim 1, wherein the container is a first container, and wherein a second container identical to the first container is stacked atop the first container, wherein at least (a) the lower surface of the second container rests atop the upper surface of the braces of the first container or (b) the lip of the second container rests atop the upper edges of the container walls of the first container.

4. The container as claimed in claim 1, wherein the container walls define a rectangle.

5. The container as claimed in claim 1, wherein the grid walls define a rectangle.

6. The container as claimed in claim 1, wherein the grid includes a plurality of rectangular compartments.

7. A container designed and arranged for the transport of rooted plant cuttings, comprising:
a base having a lower surface, a grid mounted on the lower surface, and grid walls surrounding the grid, the grid comprising a plurality of compartments, the base further including a peripheral outwardly-extending lip extending from the grid walls; and
container walls configured to rest atop the lip and surround the grid, the container walls including braces in intersecting corners thereof, the braces having upper and lower surfaces and being sized and positioned so that the lower surfaces rest on or above upper corners of the grid;
the container being made substantially of wood or rigid woody material;
wherein the container walls define a rectangle;
wherein the grid walls define a rectangle; and
wherein the grid includes a plurality of rectangular compartments.
